(19) United States
(12) Patent Application Publication
(10) Pub. No.: US 2009/0148165 A1
(43) Pub. Date: Jun. 11, 2009

(54) OPTICAL FILTERING APPARATUS AND OPTICAL COMMUNICATION SYSTEM

(75) Inventors: Bong-kyu KIM, Daejeon (KR); Bin-yeong Yoon, Daejeon (KR); Young-tak Han, Daejeon (KR); Yool Kwon, Busan (KR); Bong-tae Kim, Deajeon (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/134,893

(22) Filed: Jun. 6, 2008

(30) Foreign Application Priority Data
Dec. 5, 2007 (KR) 10-2007-0125681
Mar. 20, 2008 (KR) 10-2008-0025864

(51) Int. Cl. H04J 14/02

(52) U.S. Cl. 398/68; 398/79

(57) ABSTRACT

Provided is an optical filtering apparatus which is applied to a Time Division Multiplexing Passive Optical Network (TDM-PON) based on a wavelength division multiplexing (WDM) method. The optical filtering apparatus includes: an optical signal distributing unit dividing an optical signal received from an optical line terminal into at least one optical signal with uniform output intensity, and distributing the at least one optical signal into at least one optical network unit; and a multiplexing unit combining a plurality of optical signals having different wavelengths received from the at least one optical network unit using a wavelength division multiplexing (WDM) method, and outputting the combined optical signal to the optical line terminal. Therefore, by using the optical filtering apparatus, it is possible to connect a large number of subscribers to an Optical Line Terminal (OLT) on a network such as Fiber To The Home (FTTH), thereby increasing efficiency in costs.

### CROSS REFERENCE TO RELATED APPLICATIONS

This application claims priority from Korean Patent Application No. 10-2007-0125681, filed on Dec. 5, 2007, and Korean Patent Application No. 10-2008-0025864, filed on Mar. 20, 2008, the disclosures of which are incorporated herein in their entireties by reference.

### BACKGROUND OF THE INVENTION

1. Field of the Invention

The present invention relates to an optical filtering apparatus, and more particularly, to an optical filtering apparatus which is used in a Time Division Multiplexing-based Passive Optical Network (TDM-PON) to which wavelength division multiplexing (WDM) is applied.

2. Description of the Related Art

In a Time Division Multiplexing Passive Optical Network (TDM-PON), a plurality of optical network units (ONUs) are connected to an optical line terminal (OLT).

The plurality of ONUs share the OLT including an optical source and an optical transceiver and optical lines. Accordingly, the ONUs can share costs for installing optical fibers and costs for installing the OLT. That is, service costs per one ONU can be reduced.

The greater the number of ONUs connected to an OLT, the less the service cost per one ONU. However, when a large number of ONUs are connected to an OLT, optical loss is introduced by an optical splitter. Also, since an optical receiver can detect an optical signal with low error rate only if its output intensity is higher than a reference output intensity, an optical source having high output intensity is needed in order to connect a large number of ONUs to an OLT. Increasing the number of ONUs capable of sharing an OLT in spite of an increase in costs of the OLT will be advantageous in view of total cost. Accordingly, by increasing the output intensity of an optical source utilized in the OLT, service costs per one ONU can be reduced.

However, increasing the output intensity of optical sources utilized in ONUs is economically inefficient because it increases the service cost per one ONU in proportion to an increase in costs of the ONUs. Accordingly, in the case of upstream transmission, there is a limit in increasing the optical output intensity.

Also, in a conventional TDM-PON, an optical splitter combines optical signals having the same wavelength, which are received from an ONU1, ONU2, . . . , ONUn. In this case, optical loss corresponding to optical loss of downstream signals is generated.

In a TDM-PON method in which loss of original signals inevitably occurs, there are difficulties in restoring the original signals through time division multiplexing. That is, in order to compensate for optical loss generated in parts at which ONUs are coupled, receiver sensitivity of an optical receiver needs to be enhanced or appropriate processing needs to be performed. However, enhancing the receiver sensitivity of the optical receiver is very difficult, and reducing optical loss in the conventional TDM-PON also is not easy.

### SUMMARY OF THE INVENTION

The present invention provides a method of connecting a large number of subscribers to an OLT on a Time Division Multiplexing Passive Optical Network (TDM-PON) based on Wavelength Division Multiplexing (WDM), thereby increasing efficiency of the TDM-PON.

The present invention also provides a method of minimizing optical loss when combining optical signals transmitted as uplink signals from a plurality of ONUs and transferring the combined signal to an OLT.

According to an aspect of the present invention, there is provided an optical filtering apparatus including: an optical signal distributing unit dividing an optical signal received from an OLT into at least one optical signal with uniform output intensity, and distributing the at least one optical signal into at least one optical network unit; and a multiplexing unit combining a plurality of optical signals having different wavelengths received from the at least one optical network unit using a wavelength division multiplexing (WDM) method, and outputting the combined optical signal to the OLT.

According to another aspect of the present invention, there is provided an optical communication system including: an OLT including a light source, and at least one communication unit outputting an optical signal generated by the light source, and receiving an optical signal from the outside; at least one optical network unit outputting an optical signal having a predetermined wavelength; and an optical filtering apparatus including an optical signal distributing unit dividing an optical signal received from the OLT into at least one optical signal with uniform output intensity and distributing the at least one optical signal into the at least one optical network unit, and a multiplexing unit combining a plurality of optical signals having different wavelengths received from the at least one optical network unit using a wavelength division multiplexing (WDM) method and outputting the combined optical signal to the OLT.

Therefore, it is possible to reduce coupling loss of uplink signals outputted from a plurality of ONUs on a TDM-PON. In a conventional TDM-PON system illustrated in FIG. 8, downlink signal patterns (a) and uplink signal patterns (b) are transmitted and received between an OLT 100 and an optical splitter 800 on a TDM-PON, and when signals having the same wavelength are combined through the optical splitter 800, signal loss is introduced.

However, according to the present invention, it is possible to reduce signal loss which can be generated by signal coupling based on the TDM-PON. Accordingly, since a large number of subscribers can be connected to an OLT on the TDM-PON, it is possible to further increase cost efficiency.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a configuration view of an optical communication system according to an embodiment of the present invention;

FIG. 2 is a configuration view of an optical communication system according to another embodiment of the present invention;

FIG. 3 is a configuration view of an optical communication system according to still another embodiment of the present invention;

FIG. 4 is a block diagram of an optical filtering apparatus according to an embodiment of the present invention;

FIGS. 5 through 7 are configuration views of optical filtering apparatuses according to another embodiments of the present invention; and

FIG. 8 is a configuration view of a conventional Time Division Multiplexing-Passive Optical Network (TDM-PON).

### DETAILED DESCRIPTION OF EXEMPLARY EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

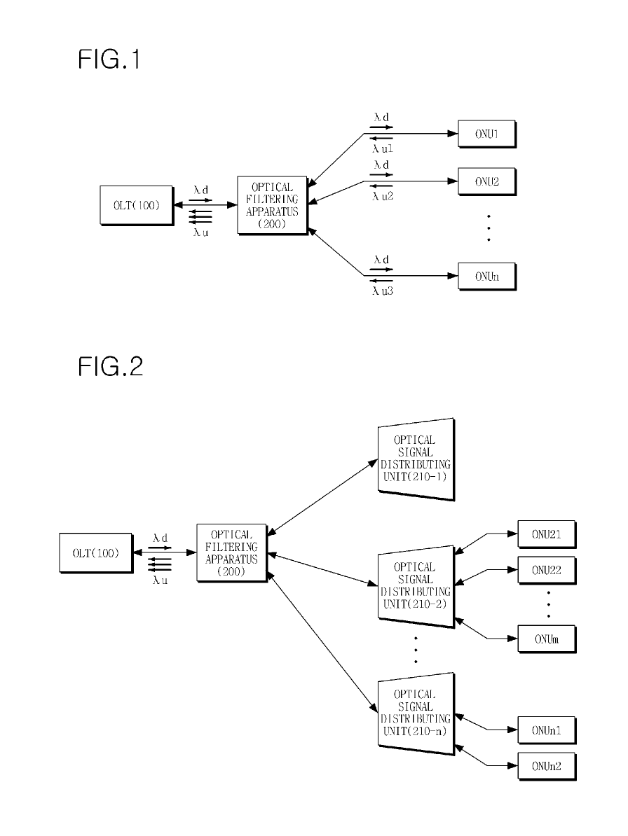

FIG. 1 is a configuration view of an optical communication system according to an embodiment of the present invention. As illustrated in FIG. 1, the optical communication system includes: an optical line terminal (OLT) 100 including a light source, and at least one communication unit which outputs an optical signal generated by the light source and receives an optical signal from the outside; at least one optical network unit (ONU) which outputs an optical signal having a predetermined wavelength ; and an optical filtering apparatus 200 including an optical signal distributing unit which divides an optical signal received from the OLT 100 into at least one optical signal with uniform output intensity and distributes at least one optical signal into the at least one ONU, and a multiplexing unit which combines a plurality of optical signals having different wavelengths received from the at least one ONU using a wavelength division multiplexing (WDM) method and outputs the combined optical signal to the OLT.

The OLT 100, which is an OLT of a service provider, is a multiservice apparatus for connecting an optical subscriber network to another system. The OLT 100 may be a service interface and protocol processing (SIPP) apparatus, a CATV apparatus, a transmission apparatus, or a network management apparatus. Functionally, the OLT 100 provides multiservice access functions: accessing a common channel signaling service (CCSS) in a personal switched telephone network (PSTN) and an integrated services digital network (ISDN), accessing a local switch in channel associated signaling (CAS), interfacing in a Packet Switched Public Data Network (PSPDN), accessing a headend in a CATV network, accessing an Asynchronous Transfer Mode (ATM) in a broadband convergence network, and accessing a broadband service such as the Internet.

The ONU is a terminal of an optical communication network which provides a service interface to end users. The ONU uses Fiber To The Curb (FTTC), Fiber To The Building (FTTB), Fiber To The Floor (FTTF), Fiber To The Office (FTTO), etc., in order to provide high accessibility to users. Also, the ONU may be installed in a subscriber's house, and transforms an image signal interface or a communication interface, such as a user-network interface of a Narrowband Integrated Services Digital Network (N-ISDN), a user-network interface of a Broadband Integrated Service Digital Network (B-ISDN), etc., to access an optical fiber network.

The filtering apparatus 200 outputs optical signals having a wavelength λ_{d} to N ONUs, respectively. That is, the wavelengths of downlink signals outputted to the N ONUs are the same. The transmittance T of an optical signal which is output to each ONU is 1/N of the transmittance of an optical signal outputted from OLT 100.

Meanwhile, as illustrated in FIG. 1, optical signals received from the ONUs by the optical filtering apparatus 200 have different wavelengths of λᵤ₁, λᵤ₂, . . . , λᵤₙ. Accordingly, the uplink signals having the different wavelengths of λᵤ₁, λᵤ₂, . . . , λᵤₙ are combined by a wavelength filter such as a WDM coupler. The WDM method can reduce coupling loss compared to a TDM-PON method which combines signals having the same wavelength with each other.

FIG. 2 is a configuration view of an optical communication system according to another embodiment of the present invention.

As illustrated in FIG. 2, the optical communication system includes a plurality of optical splitters 210-1, 210-2, . . . , 210-n between an optical filtering apparatus 200 and a plurality of ONUs. In the current embodiment of the present invention, the optical splitters 210-1, 210-2, . . . , 210-n divide an optical signal of an OLT into a plurality of optical signals and output the plurality of signals to the plurality of ONUs, or transfer a plurality of optical signals received from the plurality of ONUs to the optical filtering apparatus 200.

Here, one or more ONUs can be grouped into one group, and ONUs belonging to the same group output optical signals having the same wavelength. For example, an optical signal having a wavelength λ_{d} which is output from the OLT is output to a plurality of optical splitters 210-1, 210-2, . . . , 210-n through the optical signal filtering apparatus 200. The plurality of optical splitters 210-1, 210-2, . . . , 210-n transfer the optical signal to the plurality of ONUs. ONUs connected to an optical splitter can be set to a group. ONUs connected to an optical splitter, that is, ONUs belonging to a group output optical signals having the same wavelength to the optical splitter. That is, optical signals having different wavelengths are output from different ONU groups connected to different optical splitters.

For example, when n optical splitters 210-1, 210-2, . . . , 210-n are connected to an optical filtering apparatus and m ONUs are connected to each optical splitter, the amplitude of a downlink optical signal transferred to each ONU is reduced to 1/(m*n) of that of an optical signal outputted from a light source of the OLT. In order to compensate for loss of the optical signal, the output intensity of the light source of the OLT is increased. Meanwhile, the intensity of optical signals that are to be transferred from the ONUs is reduced to 1/m by the optical splitters 210-1, 210-2, . . . , 210-n.

Here, the wavelengths of optical signals transferred from the optical splitters 210-1, 210-2, . . . , 210-n to the optical filtering apparatus 200 are different from each other. That is, the optical filtering apparatus 200 combines optical signals having different wavelengths received from the optical splitters 210-1, 210-2, . . . , 210-n using a WDM method. In this case, since no coupling loss occurs, the amplitude of an optical signal transmitted to the OLT is reduced to 1/m of that of an optical signal outputted from a light source of the OLT. That is, since no coupling loss is introduced by the optical filtering apparatus 200, light sources having relatively low output intensity can be utilized in the ONUs and more ONUs can be connected to the OLT.

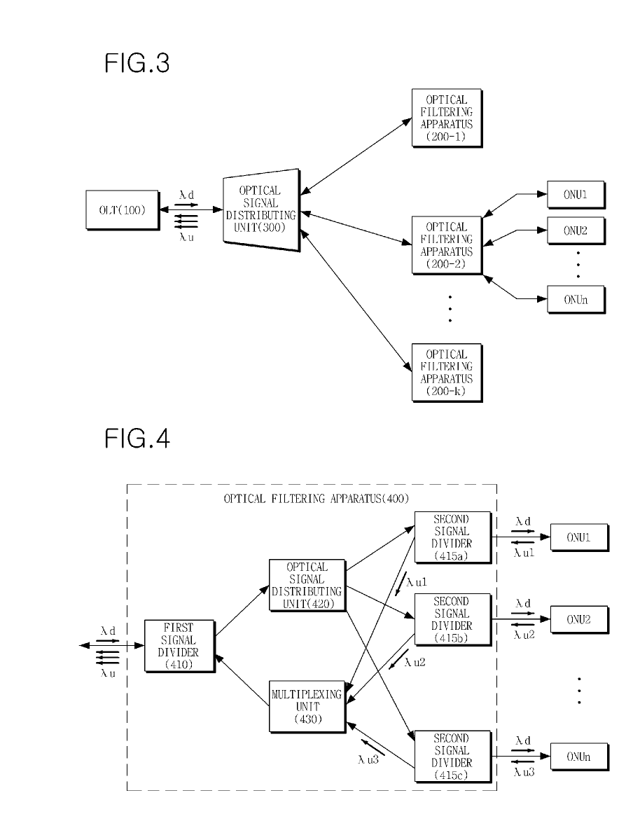

FIG. 3 is a configuration view of an optical communication system according to another embodiment of the present invention.

As illustrated in FIG. 3, the optical communication system includes an optical signal distributing unit 300 between an OLT 100 and a plurality of optical filtering apparatuses 200-1, 200-2, . . . , 200-k. In order to connect the plurality of ONUs to the OLT 100, an optical signal distributing unit 300 can be installed between the OLT 100 and the optical filtering apparatuses 200-1, 200-2, . . . , 200-k. Various modifications for efficiently connecting more ONUs to an OLT, other than the embodiments of the optical communication systems illustrated in FIGS. 3 and 4, are possible.

Hereinafter, an optical filtering apparatus according to an embodiment of the present invention will be described in detail with reference to FIG. 4.

FIG. 4 is a block diagram of an optical filtering apparatus 400 according to an embodiment of the present invention. As illustrated in FIG. 4, the optical filtering apparatus 400 includes a first signal divider 410 for separating uplink signals from downlink signals, an optical signal distributing unit 420, a multiplexer 430, and a plurality of second signal dividers 415a, 415b, and 415c.

An optical signal received from an OLT through an input/output terminal is transferred to the optical signal distributing unit 420 through an upper output terminal of the first signal divider 410. The optical signal distributing unit 420 divides the received optical signal into a plurality of optical signals and distributes the divided optical signals to a plurality of ONUs through a plurality of terminals. Here, the optical signal distributing unit 420 divides the optical signal received from the OLT into the plurality of optical signals with uniform output intensity, and distributes the plurality of optical signals to the plurality of ONUs. In the current embodiment, the optical signal distributing unit 420 may be an optical splitter.

Also, the optical signals output from the optical signal distributing unit 420 are transferred to input/output terminals connected respectively to the ONUs, through the second signal dividers 415a, 415b, and 415c. The optical signal distributing unit 420 can transfer optical signals with the same amplitude to the respective input/output terminals of the ONUs.

The multiplexer 430 transfers a plurality of optical signals received from the plurality of ONUs to the OLT, according to a WDM method. The optical signals received from the plurality of ONUs through the second signal dividers 415a, 415b, and 415c have different wavelengths. In the current embodiment, the multiplexing unit 430 may be a wavelength division multiplexing (WDM) filter, such as an arrayed waveguide grating (AWG), for multiplexing a plurality of optical signals having different wavelengths. Accordingly, the multiplexing unit 430 can transfer a plurality of optical signals to the OLT without coupling loss.

Here, the first signal dividing unit 410 and the second signal dividers 415a, 415b, and 415c may be WDM filters or circulators. In the current embodiment, the first signal divider 410 separates a path through which an optical signal that is to be transferred from the OLT to the optical signal distributing unit 420 passes, from a path through which an optical signal that is to be transferred from the multiplexing unit 430 to the OLT passes.

Also, the second signal dividers 415a, 415b, and 425c separate a path through which a signal that is to be transferred from the optical signal distributing unit 420 to the ONUs passes, from a path through which a signal that is to be transferred from the ONUs to the multiplexing unit 430 passes.

FIGS. 5 through 7 are configuration views of optical filtering apparatuses according to another embodiments of the present invention.

In detail, an optical filtering apparatus 500 illustrated in FIG. 5 uses a thin film filter. In the optical filtering apparatus 500, a thin film WDM filter 510 and a multiplexing unit 530 correspond respectively to the first signal divider 410 and the second signal dividers 415a, 415b and 415c described above with reference to FIG. 4. Also, the multiplexing unit 530 may include a plurality of thin film WDM filters and a plurality of thin film mirrors. That is, as illustrated in FIG. 5, optical signals having different wavelengths λᵤ₁, λᵤ₂, λᵤ₃, and λᵤ₄ are combined and provided to an OLT 100. The optical signal distributing unit 520 may include a plurality of thin film mirrors. The numbers and arrangements of the thin film filters and thin film mirrors are not limited to the current embodiment shown in FIG. 5, and various modifications are possible. The number and arrangement of the thin film WDM filters included in the multiplexing unit 530, and the number and arrangement of the thin film mirrors included in the optical signal distributing unit 520 can also vary according to the number of input/output terminals, that is, according to the number of ONUs connected to the OLT.

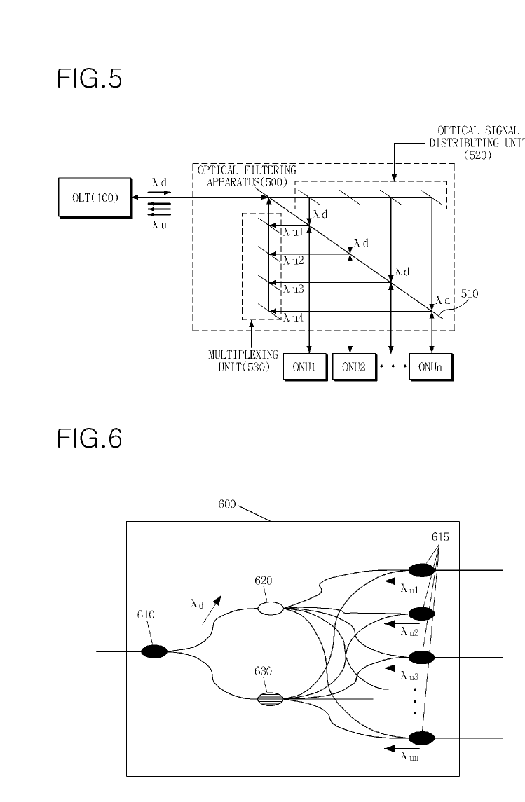

FIG. 6 shows an optical filtering apparatus 600 including a photonic lightwave filter, such as an optical fiber or a photonic lightwave circuit (PLC). A first signal divider 610 and a plurality of second signal dividers 615 may be photonic waveguide bidirectional signal dividers. Also, an optical signal divider 620 may be a directional coupler, a waveguide splitter, a Y-branch, etc. A multiplexer 630 may be an AWG, diffraction lattices, a WDM filter, etc. In the current embodiment, a plurality of optical signals having different wavelengths can be received from an OLT 100.

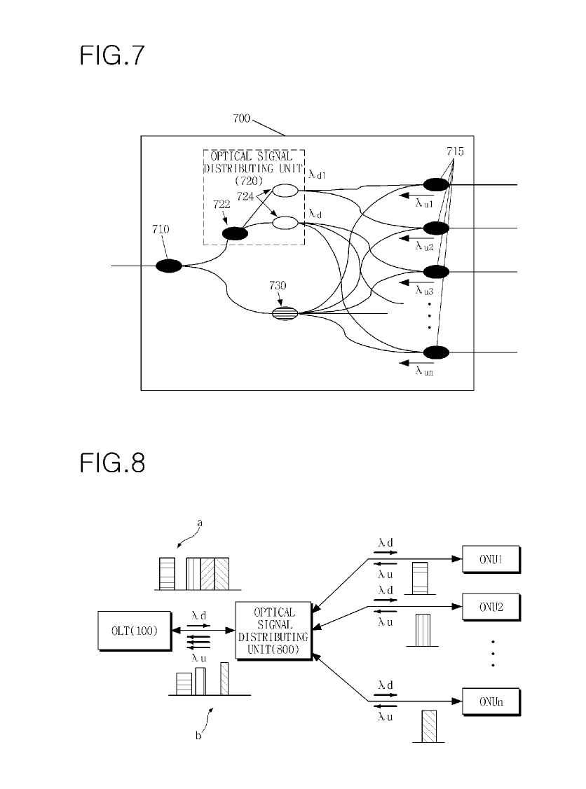

FIG. 7 shows an optical filtering apparatus 700 including a photonic waveguide filter for transmitting a plurality of optical signals having various wavelengths to a large number of input/output terminals. A first signal divider 710 and a second signal divider 715 may be photonic waveguide bidirectional dividers. A signal received from an OLT is input to the first signal divider 710 and output through an upper terminal of the first signal divider 710. In the current embodiment, an optical signal distributing unit 720 includes a wavelength divider 722 and a sub optical signal distributing unit 724. Due to the configuration of the optical signal distributing unit 720, it is possible to receive optical signals having various wavelengths. A multiplexing unit 730 may be an AWG, diffraction lattices, a WDM filter, etc.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. An optical filtering apparatus comprising:
an optical signal distributing unit dividing an optical signal received from an optical line terminal into at least one optical signal with uniform output intensity, and distributing the at least one optical signal into at least one optical network unit; and
a multiplexing unit combining a plurality of optical signals having different wavelengths received from the at least one optical network unit using a wavelength division multiplexing (WDM) method, and outputting the combined optical signal to the optical line terminal.

2. The optical filtering apparatus of claim 1, further comprising:
a first signal divider separating a path through which the optical signal transferred from the optical line terminal to the optical signal distributing unit passes, from a path through which the combined optical signal transferred from the optical signal distributing unit to the optical line terminal passes; and
a second signal divider separating a path through which the at least one optical signal transferred from the optical signal distributing unit to the at least one optical network unit passes, from a path through which the plurality of optical signals transferred from the at least one optical network unit to the multiplexing unit passes.

3. The optical filtering apparatus of claim 2, wherein the first signal divider is a WDM coupler.

4. The optical filtering apparatus of claim 2, wherein the first signal divider is an optical circulator.

5. The optical filtering apparatus of claim 2, wherein the second signal divider is a WDM coupler.

6. The optical filtering apparatus of claim 2, wherein the second signal divider is an optical circulator.

7. The optical filtering apparatus of claim 1, wherein the multiplexing unit is a WDM filter.

8. The optical filtering apparatus of claim 1, further comprising a thin film filter.

9. The optical filtering apparatus of claim 1, further comprising an arrayed waveguide filter.

10. An optical communication system comprising:
an optical line terminal including a light source, and at least one communication unit outputting an optical signal generated by the light source, and receiving an optical signal from the outside;
at least one optical network unit outputting an optical signal having a predetermined wavelength; and
an optical filtering apparatus including an optical signal distributing unit dividing an optical signal received from the optical line terminal into at least one optical signal with uniform output intensity and distributing the at least one optical signal into the at least one optical network unit, and a multiplexing unit combining a plurality of optical signals having different wavelengths received from the at least one optical network unit using a wavelength division multiplexing (WDM) method and outputting the combined optical signal to the optical line terminal.

11. The optical communication system of claim 10, wherein the at least one optical network unit is grouped to one or more groups, and at least one optical network unit belonging to the same group outputs an optical signal having the same wavelength.

12. The optical communication system of claim 10, further comprising an optical signal divider distributing an optical signal received from the optical line terminal into at least one optical filtering apparatus, combining a plurality of optical signals received from the at least one optical filtering apparatus, and transferring the combined optical signal to the optical line terminal.
